(19) United States
(12) Patent Application Publication
(10) Pub. No.: US 2026/0302545 A1
(43) Pub. Date: Oct. 1, 2026

(54) BATTERY CELL AND METHOD OF MANUFACTURING BATTERY CELL

(71) Applicant: AESC JAPAN LTD., Kanagawa (JP)

(72) Inventor: Takao DAIDOJI, Kanagawa (JP)

(21) Appl. No.: 19/475,827

(22) PCT Filed: Dec. 15, 2023
(86) PCT No.: PCT/JP2023/045063

§ 371 Date: Oct. 16, 2025

(30) Foreign Application Priority Data
Apr. 21, 2023 (JP) 2023-070016

(51) Int. Cl. H01M 50/533; H01M 10/0587; H01M 10/658; H01M 50/15; H01M 50/536

(52) U.S. Cl. CPC H01M 50/533; H01M 10/0587; H01M 10/658; H01M 50/15; H01M 50/536

(57) ABSTRACT

The battery cell (10A) includes a battery element (100) having a predetermined end surface from which a positive electrode current collector (110) is drawn out, a front lid member (210) that covers the predetermined end surface of the battery element (100), and a connecting conductor (310A) that has a first conductor portion (312A) electrically connected to the positive electrode current collector (110) and a second conductor portion (314A) electrically connected to the front lid member (210). The connecting conductor (310A) is bent between the first conductor portion (312A) and the second conductor portion (314A).

### TECHNICAL FIELD

The present invention relates to a battery cell and a method of manufacturing a battery cell.

### BACKGROUND ART

In recent years, various battery cells have been developed. The battery cell includes a battery element including a positive electrode, a negative electrode, and a separator. A positive electrode current collector and a negative electrode current collector are drawn out from the battery element. The positive electrode current collector is electrically connected to the positive electrode of the battery element. The negative electrode current collector is electrically connected to the negative electrode of the battery element.

Patent Document 1 discloses an example of a battery cell. In the battery cell, a cover having a positive electrode sheet and a cover having a negative electrode sheet cover both end surfaces of the battery element. The positive electrode current collector and the positive electrode sheet are fixed to each other through a conductor sheet provided on one of the both end surfaces of the battery element. The negative electrode current collector and the negative electrode sheet are fixed to each other through a conductive sheet provided on the other of the both end surfaces of the battery element.

Patent Document 2 discloses an example of a battery cell. The battery cell includes a current collector member having a pair of connecting bodies. Each connecting body is connected to a current collector drawn out from the battery element. Each connecting body is bent in parallel to the end surface of the battery element.

### RELATED DOCUMENT

### Patent Document

Patent Document 1: Chinese Patent Application Publication No. 115275454
Patent Document 2: U.S. Pat. No. 11,417,935

### SUMMARY OF THE INVENTION

### Technical Problem

For example, as disclosed in Patent Document 1 the current collector and the lid member may be electrically connected to each other through a connecting conductor. However, when the lid member and the connecting conductor are simply joined to each other by a joining method such as laser welding, heat generated by the connection between the lid member and the connecting conductor may affect the battery element.

An example of the object of the present invention is to reduce the influence of heat generated by the connection between the lid member and the connecting conductor on the battery element. Other objects of the present invention will be apparent from the description of the present specification.

### Solution to Problem

One aspect of the present invention is as follows.

[1]

A battery cell including:
a battery element having a predetermined end surface from which a current collector is drawn out,
a lid member that covers the predetermined end surface of the battery element, and
a connecting conductor that has a first conductor portion electrically connected to the current collector and a second conductor portion electrically connected to the lid member,
in which the connecting conductor is bent between the first conductor portion and the second conductor portion.
   [2]

The battery cell according to [1], in which at least a part of the current collector is bent non-perpendicularly with respect to the predetermined end surface of the battery element.

[3]

The battery cell according to [2], in which the connecting conductor further has a protruding conductor portion that protrudes from the first conductor portion and is joined to the current collector.

[4]

The battery cell according to [2], in which the first conductor portion and the current collector are joined to each other at a position overlapping the predetermined end surface of the battery element.

[5]

The battery cell according to [4], further including: a thermally insulating material that is positioned between the position at which the first conductor portion and the current collector are joined to each other and the predetermined end surface of the battery element.

[6]

The battery cell according to any one of [1] to [5], in which a rigidity of a bent portion of the connecting conductor between the first conductor portion and the second conductor portion is lower than at least one of a rigidity of the first conductor portion and a rigidity of the second conductor portion.

[7]

The battery cell according to any one of [1] to [6], in which the lid member has a metal portion that is electrically connected to the second conductor portion and a resin portion that surrounds the metal portion.

[8]

The battery cell according to [7], in which the metal portion has at least one of a recessed portion and a protruding portion at an interface between the metal portion and the resin portion.

[9]

A method of manufacturing a battery cell, the method including:
a step of electrically connecting a current collector drawn out from a predetermined end surface of a battery element and a first conductor portion of a connecting conductor to each other,
a step of electrically connecting a lid member and a second conductor portion of the connecting conductor to each other, and
a step of bending the connecting conductor between the first conductor portion and the second conductor portion to cover the predetermined end surface of the battery element with the lid member.
   [10]

The method of manufacturing a battery cell according to [9], in which the step of electrically connecting the lid member and the second conductor portion to each other includes a step of joining the lid member and the second conductor portion to each other when the second conductor portion is non-parallel to the predetermined end surface of the battery element.

[11]

The method of manufacturing a battery cell according to [9] or [10], in which the step of electrically connecting the current collector and the first conductor portion to each other includes a step of bending at least a part of the current collector non-perpendicularly with respect to the predetermined end surface of the battery element.

[12]

The method of manufacturing a battery cell according to [11], in which the step of electrically connecting the current collector and the first conductor portion to each other includes a step of joining the current collector and a protruding conductor portion that protrudes from the first conductor portion of the connecting conductor to each other.

[13]

The method of manufacturing a battery cell according to [11], in which the step of electrically connecting the current collector and the first conductor portion to each other includes a step of joining the current collector and the first conductor portion to each other at a position overlapping the predetermined end surface of the battery element.

[14]

The method of manufacturing a battery cell according to [13], in which in the step of joining the current collector and the first conductor portion to each other, a thermally insulating material is positioned between the position at which the first conductor portion and the current collector are joined to each other and the predetermined end surface of the battery

### Advantageous Effects of Invention

According to the aspect of the present invention, the influence of heat generated by the joining of the lid member and the connecting conductor on the battery element can be reduced.

### BRIEF DESCRIPTION OF THE DRAWINGS

FIG. 1 A perspective view of a battery cell according to Embodiment 1.

FIG. 2 A perspective view of the battery cell according to Embodiment 1 with an exterior film removed.

FIG. 3 A top view of a front portion of the battery cell according to Embodiment 1 with a positive electrode terminal and the exterior film removed.

FIG. 4 A right side view of the front portion of the battery cell according to Embodiment 1 with the positive electrode terminal and the exterior film removed.

FIG. 5 A diagram for describing an example of a method of manufacturing a battery cell according to Embodiment 1.

FIG. 6 A diagram for describing an example of the method of manufacturing a battery cell according to Embodiment 1.

FIG. 7 A diagram for describing an example of the method of manufacturing a battery cell according to Embodiment 1.

FIG. 8 A top view of a front portion of a battery cell according to Embodiment 2 with a positive electrode terminal and an exterior film removed.

FIG. 9 A right side view of the front portion of the battery cell according to Embodiment 2 with the positive electrode terminal and the exterior film removed.

FIG. 10 A diagram for describing an example of a method of manufacturing a battery cell according to Embodiment 2.

FIG. 11 A diagram for describing an example of the method of manufacturing a battery cell according to Embodiment 2.

FIG. 12 A right side view of a front portion of a battery cell according to Embodiment 3 with a positive electrode terminal and an exterior film removed.

FIG. 13 A diagram for describing an example of a method of manufacturing a battery cell according to Embodiment 4.

FIG. 14 A diagram for describing an example of the method of manufacturing a battery cell according to Embodiment 4.

FIG. 15 A diagram for describing an example of the method of manufacturing a battery cell according to Embodiment 4.

FIG. 16 A diagram showing a first variant of FIG. 13.

FIG. 17 A diagram showing a second variant of FIG. 13.

FIG. 18 A diagram showing a first example of a cross section of a front lid member according to Embodiment 1 or 2.

FIG. 19 A diagram showing a second example of the cross section of the front lid member according to Embodiment 1 or 2.

FIG. 20 A diagram showing a third example of the cross section of the front lid member according to Embodiment 1 or 2.

Hereinafter, embodiments and variants of the present invention will be described with reference to the drawings. In all drawings, the same constituent elements are denoted by the Same reference signs, and a detailed description thereof will not be repeated.

Hereinafter, unless otherwise specified, A generally parallel to B means not only that A is strictly parallel to B but also that an angle of A with respect to B is equal to or greater than −5° and equal to or less than 5°. Hereinafter, unless otherwise specified, A generally perpendicular to B means not only that A is strictly perpendicular to B but also that an angle of A with respect to B is equal to or greater than 85° and equal to or less than 95°.

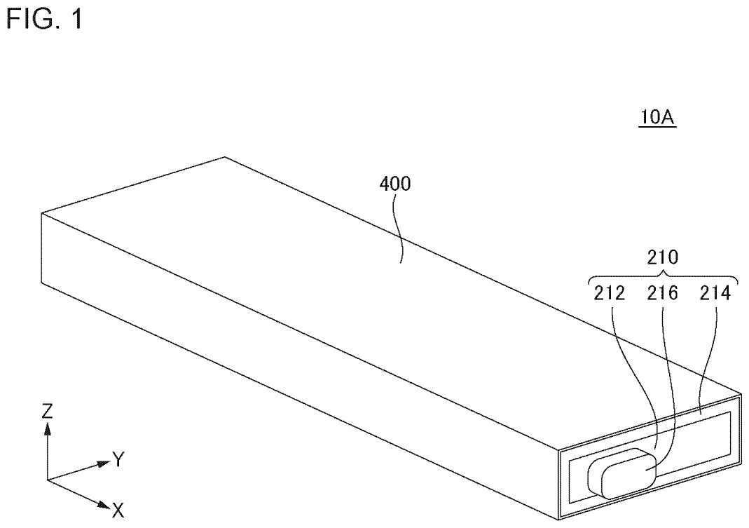

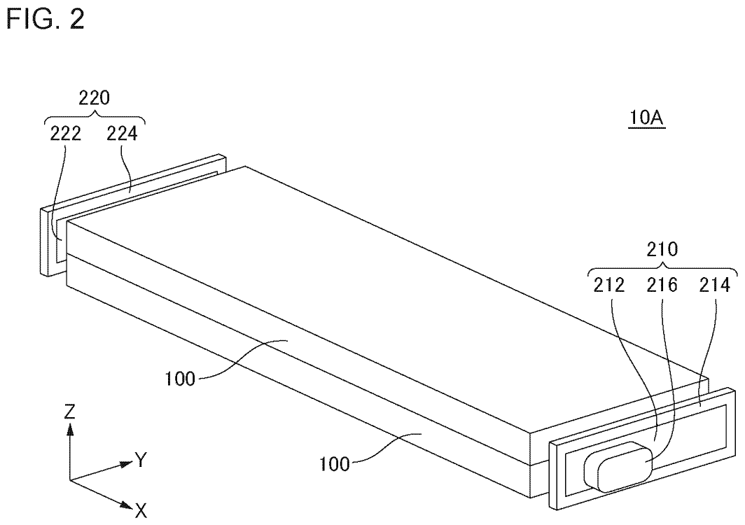

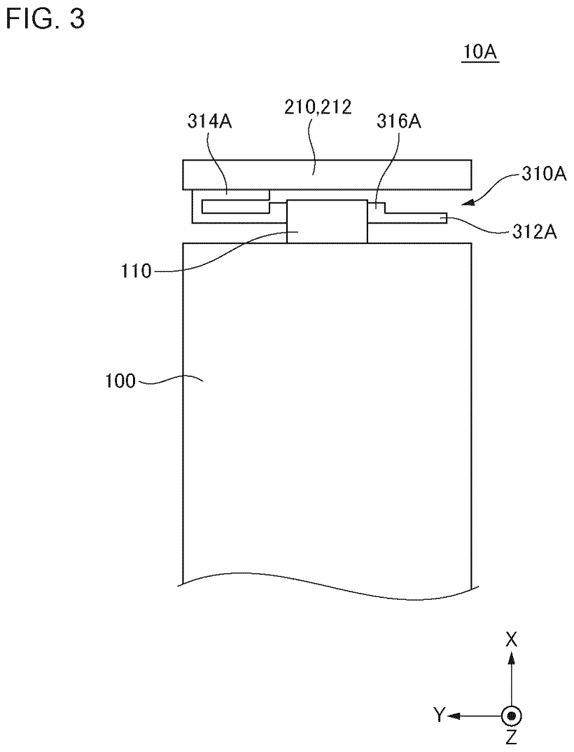

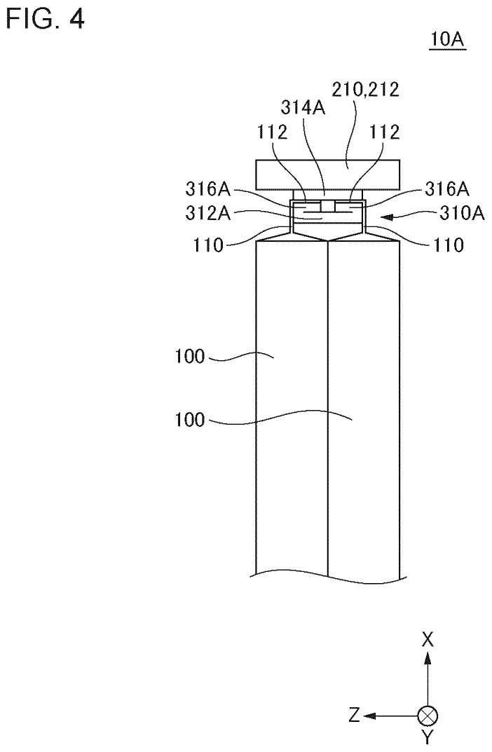

FIG. 1 is a perspective view of a battery cell 10A according to Embodiment 1. FIG. 2 is a perspective view of the battery cell 10A according to Embodiment 1 with an exterior film 400 removed. FIG. 3 is a top view of a front portion of the battery cell 10A according to Embodiment 1 with a positive electrode terminal 216 and the exterior film 400 removed. FIG. 4 is a right side view of the front portion of the battery cell 10A according to Embodiment 1 with the positive electrode terminal 216 and the exterior film 400 removed.

In each of the drawings, X direction, Y direction, and Z direction are illustrated for description. The X direction indicates a front-rear direction of the battery cell 10A. The Y direction is orthogonal to the X direction. The Y direction indicates a left-right direction of the battery cell 10A. The Z direction is orthogonal to both the X direction and the Y direction. The Z direction indicates an up-down direction of the battery cell 10A. A direction indicated by an arrow indicating the X direction, a direction indicated by an arrow indicating the Y direction, and a direction indicated by an arrow indicating the Z direction are a front direction, a left direction, and an up direction, respectively. However, the relationship between the X direction, the Y direction, the Z direction, the front-rear direction, the left-right direction, and the up-down direction of the battery cell 10A is not limited to this example. A white circle with a black dot indicating the X direction, the Y direction, or the Z direction indicates that a direction from the back of a paper surface to the front of the paper surface is a direction indicated by an arrow indicating the direction. A white circle with an X indicating the X direction, the Y direction, or the Z direction indicates that a direction from the front side of the paper surface toward the back side is a direction indicated by an arrow indicating the direction.

Hereinafter, as necessary, a side indicated by an arrow indicating the X direction and a side opposite to the side indicated by the arrow indicating the X direction will be referred to as a +X side and a −X side, respectively, a side indicated by an arrow indicating the Y direction and a side opposite to the side indicated by the arrow indicating the Y direction will be referred to as a +Y side and a −Y side, respectively, and a side indicated by an arrow indicating the Z direction and a side opposite to the side indicated by the arrow indicating the Z direction will be referred to as a +Z side and a −Z side, respectively.

The battery cell 10A will be described with reference to FIGS. 1 to 4.

The battery cell 10A includes a plurality of battery elements 100, a front lid member 210, a rear lid member 220, a connecting conductor 310A, and the exterior film 400. The front lid member 210 has a front metal portion 212, a front resin portion 214, and the positive electrode terminal 216. The rear lid member 220 has a rear metal portion 222, a rear resin portion 224, and a negative electrode terminal (not shown). The connecting conductor 310A has a first conductor portion 312A, a second conductor portion 314A, and a pair of protruding conductor portions 316A.

In Embodiment 1, as shown in FIG. 2, the plurality of battery elements 100 is stacked in the Z direction. Each of the battery elements 100 has a substantially rectangular parallelepiped shape. A longitudinal direction of the battery element 100 is generally parallel to the X direction. A lateral direction of the battery element 100 is generally parallel to the Y direction. A thickness direction of the battery element 100 is generally parallel to the Z direction. However, the shape of the battery element 100 is not limited to this example. The number of battery elements 100 included in the battery cell 10A may be only one. Hereinafter, unless otherwise specified, in Embodiment 1, the battery cell 10A will be described as comprising a plurality of battery elements 100.

The battery element 100 includes at least one positive electrode (not shown), at least one negative electrode (not shown), and at least one separator (not shown). For example, the plurality of positive electrodes and the plurality of negative electrodes are alternately stacked in the Z direction. At least a part of the separator is positioned between the positive electrode and the negative electrode adjacent to each other in the Z direction. Specifically, for example, each of the plurality of sheet-shaped separators is positioned between the positive electrode and the negative electrode adjacent to each other in the Z direction. However, one sheet-shaped separator may be alternately folded at the left end part of the positive electrode and the right end part of the negative electrode or alternately folded at the right end part of the positive electrode and the left end part of the negative electrode. Alternatively, the positive electrode, the negative electrode, and the separator may be wound such that the separator is disposed between the positive electrode and the negative electrode. For example, the positive electrode, the negative electrode, and the separator are wound with both surfaces of one of the positive electrode and the negative electrode covered with the separator. In another example, a stack including a plurality of unit stacks including the positive electrode, the separator, and the negative electrode in this order may be wound. However, the winding structure of the positive electrode, the negative electrode, and the separator is not limited to these examples.

In Embodiment 1, the battery cell 10A is a battery cell including an electrolyte. However, the battery cell 10A may be a solid-state battery. In the solid-state battery, a solid electrolyte layer is provided at a portion corresponding to the separator. The solid-state battery does not include the electrolyte. Hereinafter, the battery cell 10A will be described as a battery cell including an electrolyte unless otherwise specified.

As shown in FIGS. 3 and 4, a positive electrode current collector 110 is drawn out from the front end surface of each battery element 100. In the example shown in FIG. 4, the substantially triangular shape described in front of the front end surface of each battery element 100 schematically indicates the plurality of positive electrode current collectors 110 drawn out from the plurality of positive electrodes included in each battery element 100.

A negative electrode current collector (not shown) is drawn out from the rear end surface of each battery element 100 in the same manner as the positive electrode current collector 110 drawn out from the front end surface of each battery element 100.

The front lid member 210 covers the front end surface of the battery element 100. As viewed from the front side, the front lid member 210 has a substantially rectangular shape having a pair of long sides generally parallel to the Z direction and a pair of short sides generally parallel to the Y direction. However, the shape of the front lid member 210 is not limited to this example.

The front metal portion 212 has a substantially rectangular shape having a pair of long sides generally parallel to the Z direction and a pair of short sides generally parallel to the Y direction. The front metal portion 212 has conductivity. The front metal portion 212 and each positive electrode current collector 110 are electrically connected to each other through the connecting conductor 310A. Therefore, the front metal portion 212 can also function as a terminal electrically connected to the positive electrode of the battery element 100. Therefore, a large current can be caused to flow through the front metal portion 212 as compared with a case where the front metal portion 212 is replaced with the resin portion and a relatively thin tab is used as the terminal. In addition, the front metal portion 212 is less permeable to moisture than the front resin portion 214. Therefore, moisture can be blocked by the front lid member 210 as compared with a case where the front metal portion 212 is replaced with the resin portion.

The front resin portion 214 surrounds the front metal portion 212 around the X direction. Specifically, the front resin portion 214 extends along all sides of the front metal portion 212. The front resin portion 214 is more likely to be joined to the exterior film 400 by thermal fusion than the front metal portion 212. As will be described later, the outer peripheral surface of the front metal portion 212 and the inner peripheral surface of the front end part of the exterior film 400 may be joined to each other by thermal fusion. Therefore, it is possible to easily join the outer peripheral surface of the front lid member 210 to the inner peripheral surface of the front end part of the exterior film 400 as compared with a case Where the front resin portion 214 is replaced with the metal portion.

The rear end part of the positive electrode terminal 216 and the right end part of the front metal portion 212 are electrically connected to each other. The front end part of the positive electrode terminal 216 protrudes forward from the front surface of the front lid member 210. For example, the front metal portion 212 and the positive electrode terminal 216 may be integrated with each other. However, the position of the positive electrode terminal 216 is not limited to the example shown in FIG. 2. For example, the positive electrode terminal 216 may be positioned at the substantially central portion of the front metal portion 212 in the Y direction. Alternatively, the front lid member 210 may not have the positive electrode terminal 216. That is, the front metal portion 212 may function as the terminal.

The rear lid member 220 covers the rear end surface of the battery element 100. The description of the front lid member 210 can be similarly applied to the rear lid member 220.

As shown in FIG. 1, the exterior film 400 is wound around the battery element 100, the front lid member 210, and the rear lid member 220 around the X direction. The exterior film 400 has a substantially tubular shape that is open forward and rearward. The front lid member 210 is disposed inside the front opening of the exterior film 400. The rear lid member 220 is disposed inside the rear opening of the exterior film 400. Therefore, the front lid member 210, the rear lid member 220, and the exterior film 400 form a accommodating space that accommodates the battery element 100, the plurality of positive electrode current collectors 110, and the plurality of negative electrode current collectors. The accommodating space accommodates the battery element 100, the plurality of positive electrode current collectors 110, the plurality of negative electrode current collectors, and an electrolyte (not shown). The aspect of winding the exterior film 400 around the battery element 100 is not limited to the above-described example.

The outer peripheral surface of the front resin portion 214 around the X direction and the inner peripheral surface of the front end part of the exterior film 400 around the X direction are joined to each other by, for example, thermal fusion. Therefore, a sealing portion is formed between the outer peripheral surface of the front resin portion 214 around the X direction and the inner peripheral surface of the front end part of the exterior film 400 around the X direction.

The outer peripheral surface of the rear resin portion 224 around the X direction and the inner peripheral surface of the rear end part of the exterior film 400 around the X direction are joined to each other by, for example, thermal fusion. Therefore, a sealing portion is formed between the outer peripheral surface of the rear resin portion 224 around the X direction and the inner peripheral surface of the rear end part of the exterior film 400 around the X direction.

For example, the exterior film 400 has a winding portion that is wound around the battery element 100, the front lid member 210, and the rear lid member 220 around the X direction in one turn, and two drawn-out portions that are drawn out from both ends of the winding portion around the X direction. In this example, the two drawn-out portions are joined to each other by, for example, thermal fusion. Therefore, a sealing portion is formed between the two drawn-out portions.

The electrical connection between the positive electrode current collector 110, the front lid member 210, and the connecting conductor 310A will be described with reference to FIGS. 3 and 4. The positive electrode current collector 110 of each battery element 100 and the front metal portion 212 of the front lid member 210 are electrically connected to each other through the connecting conductor 310A. The negative electrode current collector of each battery element 100 and the rear metal portion 222 of the rear lid member 220 are also electrically connected to each other by the same method as the method described below through the same connecting conductor as the connecting conductor 310A.

In Embodiment 1, as shown in FIG. 4, the two battery elements 100 overlap each other in the Z direction. Hereinafter, as necessary, the battery element 100 positioned on the +Z side among the two battery elements 100 will be referred to as a +Z side battery element 100, and the battery element 100 positioned on the −Z side among the two battery elements 100 will be referred to as a −Z side battery element 100.

Hereinafter, as necessary, the plurality of positive electrode current collectors 110 drawn out from the +Z side battery element 100 will be referred to as +Z side plurality of positive electrode current collectors 110, and the plurality of positive electrode current collectors 110 drawn out from the −Z side battery element 100 will be referred to as −Z side plurality of positive electrode current collectors 110.

The first conductor portion 312A has a substantially plate shape that is generally parallel to the front end surface of each battery element 100. The first conductor portion 312A extends generally perpendicularly to the X direction. The first conductor portion 312A has a longitudinal direction that is generally parallel to the Y direction and a lateral direction that is generally parallel to the X direction. The first conductor portion 312A and the two battery elements 100 overlap each other in the X direction.

The second conductor portion 314A has a substantially plate shape that is generally parallel to the front end surface of each battery element 100. The second conductor portion 314A extends generally perpendicularly to the X direction. The connecting conductor 310A is bent to face each other between the first conductor portion 312A and the second conductor portion 314A. In the example shown in FIG. 3, the connecting conductor 310A is substantially folded back by 180° between the left end part of the first conductor portion 312A and the left end part of the second conductor portion 314A. Therefore, a dimension of a region between the front end surface of the battery element 100 and the rear surface of the front lid member 210 in the X direction can be reduced as compared with a case where the connecting conductor 310A is bent at substantially a right angle between the first conductor portion 312A and the second conductor portion 314A. However, the connecting conductor 310A may be bent, for example, by substantially 90° without being substantially folded back by 180° between the first conductor portion 312A. and the second conductor portion 314A. The front surface of the second conductor portion 314A and the rear surface of the left end part of the front metal portion 212 are joined to each other. Therefore, the second conductor portion 314A and the front metal portion 212 are electrically connected to each other.

A rigidity of a bent portion of the connecting conductor 310A between the first conductor portion 312A and the second conductor portion 314A is lower than at least one of a rigidity of the first conductor portion 312A and a rigidity of the second conductor portion 314A. Therefore, the connecting conductor 310A can be easily bent between the first conductor portion 312A and the second conductor portion 314A as compared with a case where the overall rigidity of the connecting conductor 310A is relatively high to the same extent. In addition, the strengths of the first conductor portion 312A and the second conductor portion 314A can be improved as compared with a case where the overall rigidity of the connecting conductor 310A is relatively low to the same extent. For example, a hole or a notch is formed in the bent portion of the connecting conductor 310A. Alternatively, a thickness of the bent portion of the connecting conductor 310A may be partially reduced. In these examples, the rigidity of the bent portion of the connecting conductor 310A can be partially reduced. The rigidity of the bent portion of the connecting conductor 310A may be equal to the rigidity of the first conductor portion 312A and the rigidity of the second conductor portion 314A.

The pair of protruding conductor portions 316A protrude from both sides of the first conductor portion 312A in the Z direction. Hereinafter, as necessary, the protruding conductor portion 316A positioned on the +Z side among the pair of protruding conductor portions 316A will be referred to as a +Z side protruding conductor portion 316A, and the protruding conductor portion 316A positioned on the-2 side among the pair of protruding conductor portions 316A will be referred to as a −Z side protruding conductor portion 316A. The +Z side protruding conductor portion 316A protrudes from the substantially central portion of the +Z side edge of the first conductor portion 312A. The −Z side protruding conductor portion 316A protrudes from the substantially central portion of the −Z side edge of the first conductor portion 312A.

As shown in FIG. 4, the +Z side protruding conductor portion 316A and a distal end part 112 of the +Z side plurality of positive electrode current collectors 110 are bent non-perpendicularly, specifically, generally parallel to the front end surface of each battery element 100. In the example shown in FIG. 4, the +Z side protruding conductor portion 316A and the distal end part 112 of the +Z side plurality of positive electrode current collectors 110 are bent toward the −Z side. The front surface of the +Z side protruding conductor portion 316A and the rear surface of the distal end part 112 of the +Z side plurality of positive electrode current collectors 110 are joined to each other. Therefore, the +Z side protruding conductor portion 316A and the +Z side plurality of positive electrode current collectors 110 are electrically connected to each other. Therefore, the first conductor portion 312A and the +Z side plurality of positive electrode current collectors 110 are electrically connected to each other through the +Z side protruding conductor portion 316A.

As shown in FIG. 4, the −Z side protruding conductor portion 316A and a distal end part 112 of the −Z side plurality of positive electrode current collectors 110 are bent non-perpendicularly, specifically, generally parallel to the front end surface of each battery element 100. In the example shown in FIG. 4, the −Z side protruding conductor portion 316A and the distal end part 112 of the −Z side plurality of positive electrode current collectors 110 are bent toward the +Z side. The front surface of the −Z side protruding conductor portion 316A and the rear surface of the distal end part 112 of the −Z side plurality of positive electrode current collectors 110 are joined to each other. Therefore, the −Z side protruding conductor portion 316A and the −Z side plurality of positive electrode current collectors 110 are electrically connected to each other. Therefore, the first conductor portion 312A and the −Z side plurality of positive electrode current collectors 110 are electrically connected to each other through the −Z side protruding conductor portion 316A.

In Embodiment 1, the plurality of protruding conductor portions 316A can divide the joint portion between the connecting conductor 310A and the positive electrode current collector 110 into a plurality of portions. Therefore, the number of positive electrode current collectors 110 to be joined to each protruding conductor portion 316A can be reduced as compared with a case where the connecting conductor 310A and the positive electrode current collector 110 are joined to each other at only one portion. The number of positive electrode current collectors 110 that can be joined to each joint portion between the connecting conductor 310A and the positive electrode current collector 110 may have an upper limit depending on a joining condition such as welding. In Embodiment 1, by dividing the joint portion between the connecting conductor 310A and the positive electrode current collector 110 into a plurality of portions, the number of positive electrode current collectors 110 to be joined to each protruding conductor portion 316A can be set to be equal to or less than the upper limit. Therefore, the connecting conductor 310A and the positive electrode current collector 110 can be reliably joined to each other as compared with a case where the connecting conductor 310A and the positive electrode current collector 110 are joined to each other at only one portion. In other words, the total number of positive electrode current collectors 110 electrically connected to the connecting conductor 310A, that is, the thickness of the plurality of battery elements 100 in the Z direction can be increased as compared with a case where the connecting conductor 310A and the positive electrode current collector 110 are joined to each other at only one portion.

In Embodiment 1, the spreading of the +Z side protruding conductor portion 316A to the outside of the first conductor portion 312A can be reduced as compared with a case where the +Z side protruding conductor portion 316A is bent toward the +Z side. However, the +Z side protruding conductor portion 316A may be bent toward the +Z side. In this case, the +Z side plurality of positive electrode current collectors 110 and the +Z side protruding conductor portion 316A can be prevented from being positioned between the front surface of the first conductor portion 312A and the rear surface of the front lid member 210. Therefore, a width of the region between the front surface of the first conductor portion 312A and the rear surface of the front lid member 210 in the X direction can be prevented from increasing according to the thickness of the +Z side plurality of positive electrode current collectors 110 and the +Z side protruding conductor portion 316A in the X direction. The above-described matters described for the +Z side protruding conductor portion 316A are also the same for the −Z side protruding conductor portion 316A.

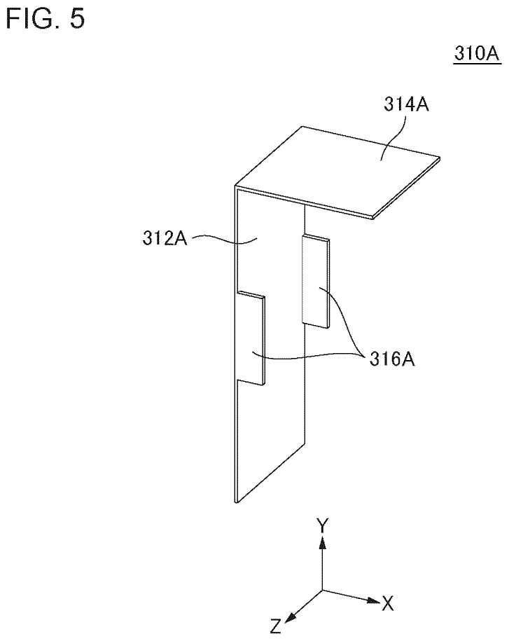

FIGS. 5 to 7 are diagrams for describing an example of a method of manufacturing the battery cell 10A according to Embodiment 1. In this example, the battery cell 10A according to Embodiment 1 is manufactured as follows.

First, the battery element 100 is formed. The battery element 100 includes at least one positive electrode, at least one negative electrode, and at least one separator. A plurality of positive electrode current collectors 110 and a plurality of negative electrode current collectors are drawn out from the battery element 100.

Next, as shown in FIG. 5, the connecting conductor 310A is prepared. In the example shown in FIG. 5, the first conductor portion 312A extends generally perpendicularly to the X direction. The +Z side end part of the first conductor portion 312A and the −X side end part of the second conductor portion 314A are bent at substantially a right angle to each other. The second conductor portion 314A extends generally perpendicularly to the Z direction. The substantially central portion of the +Y side edge of the first conductor portion 312A and the −X side end part of the +Y side protruding conductor portion 316A are bent at substantially a right angle to each other. The +Y side protruding conductor portion 316A extends generally perpendicularly to the Y direction. The substantially central portion of the −Y side edge of the first conductor portion 312A and the −X side end part of the −Y side protruding conductor portion 316A are bent generally perpendicular to each other. The −Y side protruding conductor portion 316A extends generally perpendicularly to the Y direction.

Next, the +Z side plurality of positive electrode current collectors 110 are joined to each other by a joining method such as ultrasonic welding, thereby bundling the +Z side plurality of positive electrode current collectors 110 into one bundle. Similarly, the −Z side plurality of positive electrode current collectors 110 are joined to each other by a joining method such as ultrasonic welding, thereby bundling the −Z side plurality of positive electrode current collectors 110 into one bundle.

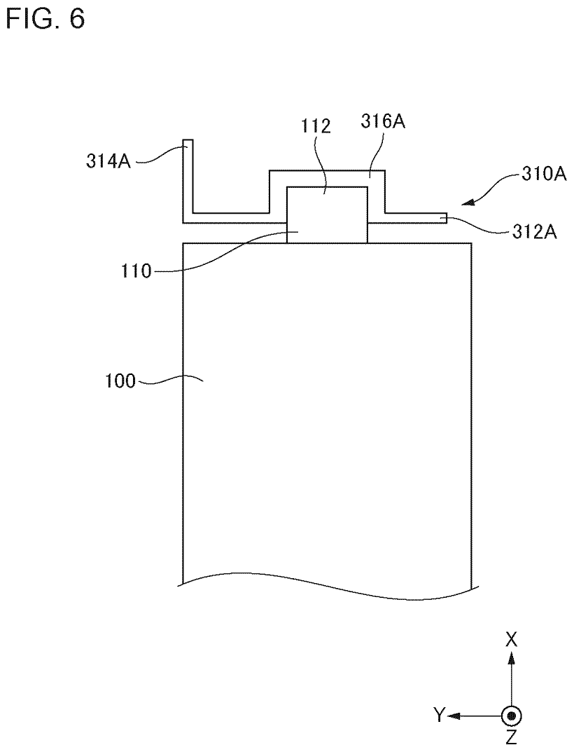

Next, as shown in FIG. 6, the −Z side surface of the +Z side plurality of positive electrode current collectors 110 bundled into one bundle and the +Z side surface of the +Z side protruding conductor portion 316A are joined to each other. In Embodiment 1, the −Z side surface of the +Z side plurality of positive electrode current collectors 110 and the +Z side surface of the +Z side protruding conductor portion 316A are welded by a laser emitted from the +Z side to the +Z side plurality of positive electrode current collectors 110. Therefore, the +Z side plurality of positive electrode current collectors 110 and the +Z side protruding conductor portion 316A are electrically connected to each other. Similarly, the +Z side surface of the −Z side plurality of positive electrode current collectors 110 bundled into one bundle and the −Z side surface of the −Z side protruding conductor portion 316A are joined to each other. In Embodiment 1, the +Z side surface of the −Z side plurality of positive electrode current collectors 110 and the −Z side surface of the −Z side protruding conductor portion 316A are welded by, for example, a laser emitted from the −Z side to the −Z side plurality of positive electrode current collectors 110. Therefore, the −Z side plurality of positive electrode current collectors 110 and the −Z side protruding conductor portion 316A are electrically connected to each other. In this example, the influence of heat generated by the welding of the positive electrode current collector 110 and the protruding conductor portion 316A on the battery element 100 can be reduced as compared with a case where the laser is emitted generally parallel to the X direction.

Next, the distal end part 112 of the +Z side plurality of positive electrode current collectors 110 and the +Z side protruding conductor portion 316A are bent substantially by 90° toward the −Z side. Similarly, the distal end part 112 of the −Z side plurality of positive electrode current collectors 110 and the −Z side protruding conductor portion 316A are bent substantially by 90° toward the +Z side. Therefore, a dimension of the region between the front end surface of the battery element 100 and the rear surface of the front lid member 210 in the X direction can be reduced as compared with a case where the positive electrode current collector 110 and the protruding conductor portion 316A are generally parallel to the X direction without being bent. Therefore, the space utilization in the battery cell 10A can be increased and the energy density of the battery cell 10A can be improved as compared with the above-described case.

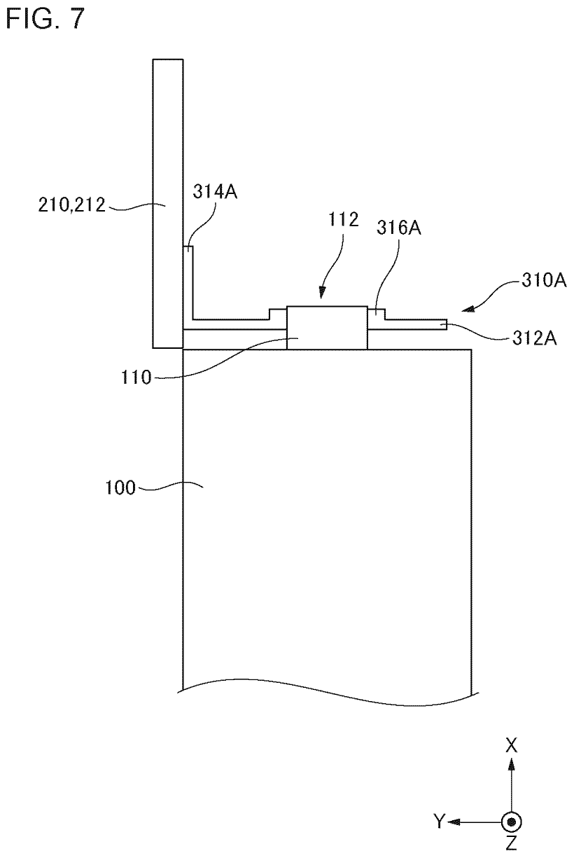

Next, as shown in FIG. 7, the second conductor portion 314A is non-parallel to the front end surface of the battery element 100, specifically, is generally perpendicular to the front end surface of the battery element 100, and the front lid member 210 is non-parallel to the front end surface of the battery element 100, specifically, is generally perpendicular to the front end surface of the battery element 100, and the lower end part of the +Y side surface of the second conductor portion 314A and the −Y side surface of the front metal portion 212 are joined to each other. Therefore, the second conductor portion 314A and the front metal portion 212 are electrically connected to each other. In Embodiment 1, the lower end part of the +Y side surface of the second conductor portion 314A and the lower end part of the −Y side surface of the front metal portion 212 are welded by a laser emitted from the −Y side to the second conductor portion 314A. Therefore, the influence of heat generated by the joining of the second conductor portion 314A and the front lid member 210 on the battery element 100 can be reduced as compared with a case where the laser is emitted generally parallel to the X direction.

Next, the second conductor portion 314A is bent toward the first conductor portion 312A. Therefore, the connecting conductor 310A is substantially folded back by 180° between the left end part of the first conductor portion 312A and the left end part of the second conductor portion 314A. By bending the connecting conductor 310A, the front lid member 210 also moves together with the second conductor portion 314A. Therefore, the front lid member 210 covers the front end surface of the battery element 100.

The negative electrode current collector and the rear lid member 220 are electrically connected to each other through the same connecting conductor as the connecting conductor 310A in the same manner as the method described with reference to FIGS. 5 to 7.

Next, the exterior film 400 is wound around the battery element 100, the front lid member 210, and the rear lid member 220 in one turn about the X direction in one turn. Next, the outer peripheral surface of the front lid member 210 around the X direction and the inner peripheral surface of the front end part of the exterior film 400 around the X direction are joined to each other by thermal fusion. Therefore, a sealing portion is formed between the outer peripheral surface of the front lid member 210 around the X direction and the inner peripheral surface of the opening of the front end part of the exterior film 400 around the X direction. Next, the outer peripheral surface of the rear lid member 220 around the X direction and the inner peripheral surface of the rear end part of the exterior film 400 around the X direction are joined to each other by thermal fusion. Therefore, a sealing portion is formed between the outer peripheral surface of the rear lid member 220 around the X direction and the inner peripheral surface of the rear end part of the exterior film 400 around the X direction. In this state, the front lid member 210, the rear lid member 220, and the exterior film 400 form a accommodating space that accommodates the battery element 100, the plurality of positive electrode current collectors 110, and the plurality of negative electrode current collectors. In this state, the exterior film 400 has two drawn-out portions that are drawn out from both ends of the winding portion wound around the battery element 100, the front lid member 210, and the rear lid member 220 around the X direction in one turn.

Next, the accommodating space is injected with the electrolyte through a gap between the two drawn-out portions of the exterior film 400. Next, the accommodating space is evacuated through a gap between the two drawn-out portions of the exterior film 400. Next, the two drawn-out portions of the exterior film 400 are joined to each other by thermal fusion to form a sealing portion. Therefore, the accommodating space is vacuum-sealed.

A method of vacuum-sealing the accommodating space is not limited to the above-described example. In another example, first, the two drawn-out portions of the exterior film 400 are joined to each other by thermal fusion to form a sealing portion. Next, the electrolyte is injected into the accommodating space through the liquid injection hole provided in at least one of the front lid member 210 and the rear lid member 220. Next, the accommodating space is vacuumed through the liquid injection hole. Next, the liquid injection hole is blocked by a predetermined lid member.

In this manner, the battery cell 10A is manufactured.

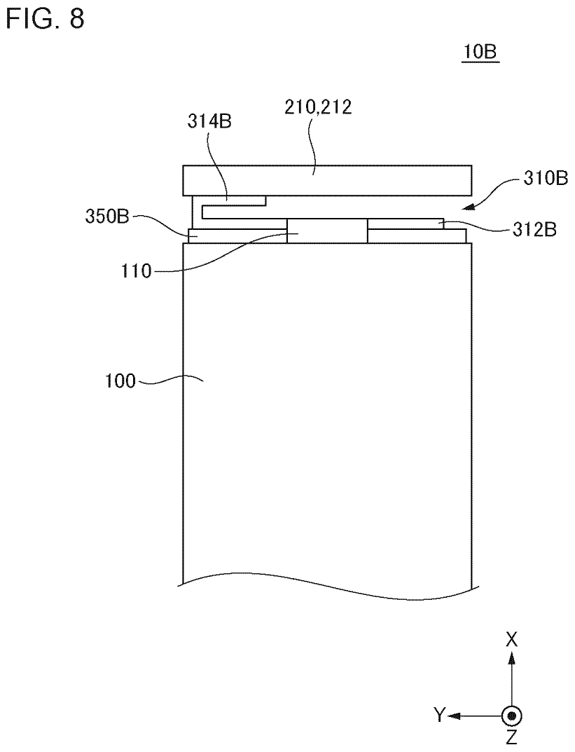

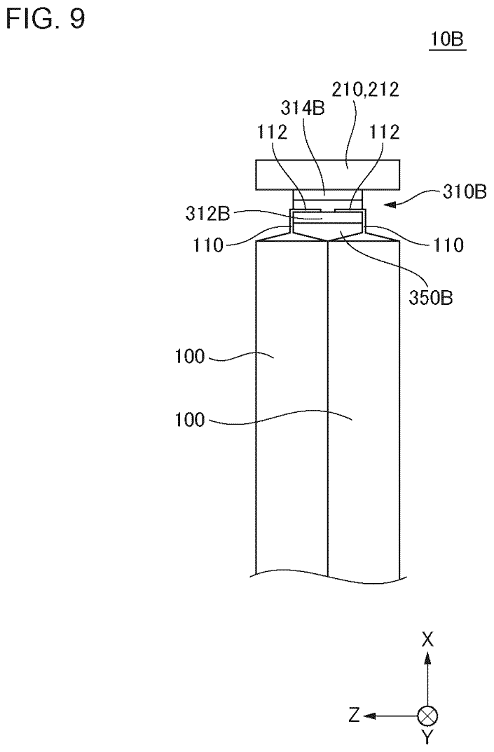

FIG. 8 is a top view of a front portion of a battery cell 10B according to Embodiment 2 with the positive electrode terminal 216 and the exterior film 400 removed. FIG. 9 is a right side view of the front portion of the battery cell 10B according to Embodiment 2 with the positive electrode terminal 216 and the exterior film 400 removed. The battery cell 10B according to Embodiment 2 is the same as the battery cell 10A according to Embodiment 1 except for the following points.

A connecting conductor 310B according to Embodiment 2 has a first conductor portion 312B and a second conductor portion 314B without having a conductor portion corresponding to the pair of protruding conductor portions 316A according to Embodiment 1.

The +Z side portion of the front surface of the first conductor portion 312B and the rear surface of the distal end part 112 of the +Z side plurality of positive electrode current collectors 110 are joined to each other. Similarly, the −Z side portion of the front surface of the first conductor portion 312B and the rear surface of the distal end part 112 of the −Z side plurality of positive electrode current collectors 110 are joined to each other. The first conductor portion 312B and the distal end part 112 of each positive electrode current collector 110 are joined to each other at a position overlapping the front end surface of the battery element 100 in the X direction. A thermally insulating material 350B is positioned between the rear surface of the first conductor portion 312B and the front end surface of each battery element 100. In Embodiment 2, the dimension of the battery cell 10B can be reduced by the absence of the conductor portion corresponding to the pair of protruding conductor portions 316A, as compared with Embodiment 1. In addition, depending on a material constituting the thermally insulating material 350B, the thermally insulating material 350B can also function as a buffer material that alleviates an impact on each battery element 100.

The connecting conductor 310B according to Embodiment 2 is substantially folded back by 180° between the left end part of the first conductor portion 312B and the left end part of the second conductor portion 314B in the same manner as the connecting conductor 310A according to Embodiment 1. The front surface of the second conductor portion 314B and the rear surface of the left end part of the front metal portion 212 are joined to each other.

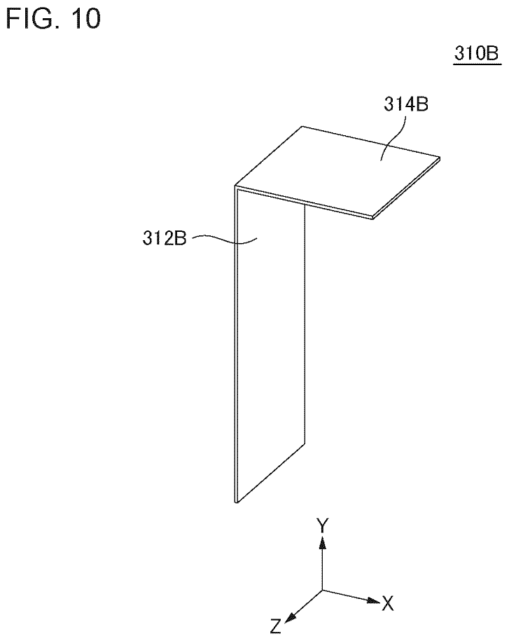

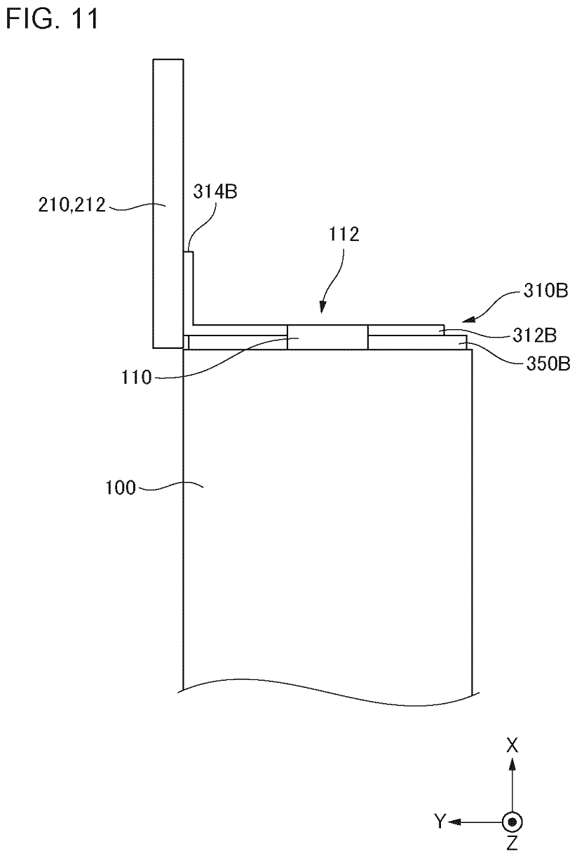

FIGS. 10 and 11 are diagrams for describing an example of a method of manufacturing the battery cell 10B according to Embodiment 2. This example is the same as the example of the method of manufacturing the battery cell 10A according to Embodiment 1, except for the following points.

First, the battery element 100 is formed in the same manner as in Embodiment 1.

Next, as shown in FIG. 10, the connecting conductor 310B is prepared. In the example shown in FIG. 10, the first conductor portion 312B extends generally perpendicularly to the X direction. The +Z side end part of the first conductor portion 312B and the −Z side end part of the second conductor portion 314B are bent at substantially a right angle to each other. The second conductor portion 314B extends generally perpendicularly to the Z direction.

Next, the +Z side plurality of positive electrode current collectors 110 are joined to each other by a joining method such as ultrasonic welding, thereby bundling the +Z side plurality of positive electrode current collectors 110 into one bundle. Similarly, the −Z side plurality of positive electrode current collectors 110 are joined to each other by a joining method such as ultrasonic welding, thereby bundling the −Z side plurality of positive electrode current collectors 110 into one bundle.

Next, as shown in FIG. 11, when the thermally insulating material 350B is disposed between the front end surface of the battery element 100 and the rear surface of the first conductor portion 312B, the +Z side plurality of positive electrode current collectors 110 bundled into one bundle are bent substantially by 90° toward the −Z side, and the −Z side plurality of positive electrode current collectors 110 bundled into one bundle are bent substantially by 90° toward the +Z side. The position of the first conductor portion 312B in the X direction with respect to the front end surface of the battery element 100 can be adjusted according to the thickness of the thermally insulating material 350B in the X direction. That is, the thermally insulating material 350B can also function as a spacer for adjusting the position of the first conductor portion 312B in the X direction with respect to the front end surface of the battery element 100.

Next, the +Z side plurality of positive electrode current collectors 110 and the −Z side plurality of positive electrode current collectors 110 are irradiated with a laser from the +X side to join the rear surface of each positive electrode current collector 110 and the front surface of the substantially central portion of the connecting conductor 310B in the Y direction to each other. When the laser is emitted, the thermally insulating material 350B is positioned between a position where each positive electrode current collector 110 and the connecting conductor 310B are joined to each other and the front end surface of the battery element 100. Therefore, the influence of heat generated by the joining of each positive electrode current collector 110 and the connecting conductor 310B on the battery element 100 can be reduced as compared with a case where the thermally insulating material 350B is not provided. The material constituting the thermally insulating material 350B is not particularly limited as long as it is a material that can shield the heat generated by the joining of each positive electrode current collector 110 and the connecting conductor 310B.

Next, the second conductor portion 314B and the front metal portion 212 are electrically connected to each other in the same manner as in Embodiment 1. The subsequent steps are the same as the method of manufacturing the battery cell 10A according to Embodiment 1.

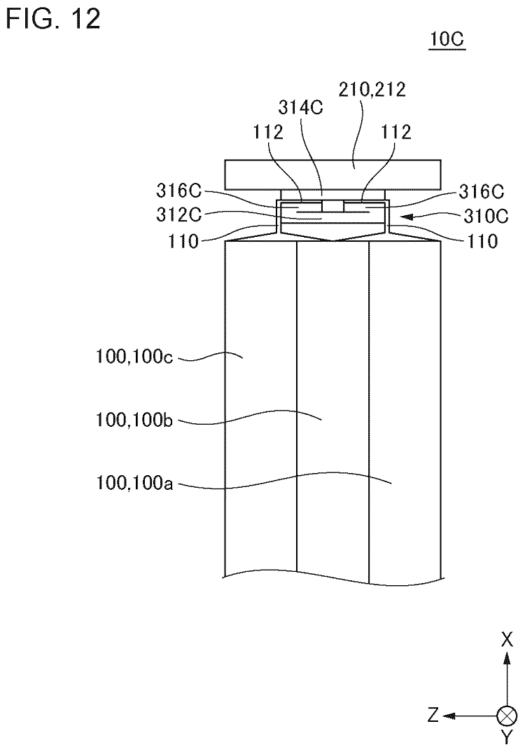

FIG. 12 is a right side view of a front portion of a battery cell 10C according to Embodiment 3 with the positive electrode terminal 216 and the exterior film 400 removed. The battery cell 10C according to Embodiment 3 is the same as the battery cell 10A according to Embodiment 1 except for the following points.

The battery cell 10C according to Embodiment 3 includes three battery elements 100 and a connecting conductor 310C. The three battery elements 100 are arranged generally parallel to the Z direction. Hereinafter, as necessary, the first battery element 100 from the −Z side will be referred to as a first battery element 100a, the second battery element 100 from the −Z side will be referred to as a second battery element 100b, and the third battery element 100 from the −Z side will be referred to as a third battery element 100c. The connecting conductor 310C according to Embodiment 3 has a first conductor portion 312C, a second conductor portion 314C, and a pair of protruding conductor portions 316C in the same manner as the connecting conductor 310A according to Embodiment 1.

In Embodiment 3, the plurality of positive electrode current collectors 110 drawn out from the first battery element 100a and a part of the positive electrode current collectors 110 drawn out from the −Z side portion of the second battery element 100b are bundled into one bundle and are joined to the −Z side protruding conductor portion 316C. Similarly, the plurality of positive electrode current collectors 110 drawn out from the third battery element 100c and the other part of the positive electrode current collectors 110 drawn out from the +Z side portion of the second battery element 100b are bundled into one bundle and are joined to the +Z side protruding conductor portion 316C. Therefore, the three battery elements 100 and the front lid member 210 can be electrically connected to each other through the connecting conductor 310C in the same manner as in Embodiment 1.

The connecting conductor 310C according to Embodiment 3 has a pair of protruding conductor portions 316C in the same manner as the connecting conductor 310A according to Embodiment 1. However, the connecting conductor 310C according to Embodiment 3 may not have the pair of protruding conductor portions 316C in the same manner as the connecting conductor 310B according to Embodiment 2. Even when the connecting conductor 310C does not have the pair of protruding conductor portions 316C, the plurality of positive electrode current collectors 110 drawn out from the first battery element 100a and the part of the positive electrode current collectors 110 drawn out from the −Z side portion of the second battery element 100b can be bundled into one bundle and can be joined to the −Z side portion of the first conductor portion 312C. Similarly, the plurality of positive electrode current collectors 110 drawn out from the third battery element 100c and the other part of the positive electrode current collectors 110 drawn out from the +Z side portion of the second battery element 100b can be bundled into one bundle and can be joined to the +Z side portion of the first conductor portion 312C.

From the description of Embodiment 1 and Embodiment 3, when the battery cell includes 2N (N is an integer of 1 or more) battery elements 100, for example, the plurality of positive electrode current collectors 110 drawn out from the N battery elements 100 on the −Z side can be bundled into one bundle and can be joined to the connecting conductor, and the plurality of positive electrode current collectors 100 drawn out from the N battery elements 100 on the +Z side can be bundled into one bundle and can be joined to the connecting conductor. When the battery cell includes 2N+1 battery elements 100, for example, the plurality of positive electrode current collectors 110 drawn out from the N battery elements 100 on the −Z side and the part of the positive electrode current collectors 110 drawn out from the +Z side portion of the one battery element 100 on the center side can be bundled into one bundle and can be joined to the connecting conductor, and the plurality of positive electrode current collectors 110 drawn out from the N battery elements 100 on the +Z side and the other part of the positive electrode current collectors 110 drawn out from the −Z side portion of the one battery element 100 on the center side can be bundled into one bundle and can be joined to the connecting conductor.

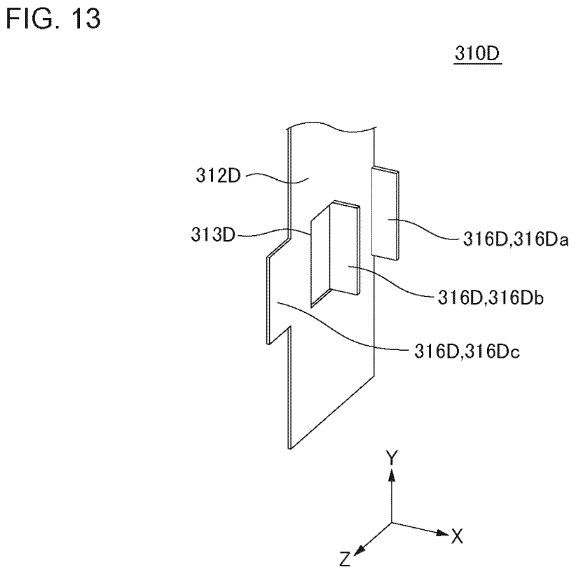

FIGS. 13 to 15 are diagrams for describing an example of a method of manufacturing the battery cell according to Embodiment 4. The method of manufacturing the battery cell according to Embodiment 4 is the same as the method of manufacturing the battery cell 10A according to Embodiment 1, except for the following points. In the method of manufacturing the battery cell according to Embodiment 4, the three battery elements 100 and the connecting conductor 310D are electrically connected to each other as follows.

As shown in FIG. 13, the connecting conductor 310D is prepared. The connecting conductor 310D according to Embodiment 4 has a first conductor portion 312D and three protruding conductor portions 316D. The three protruding conductor portions 316D are arranged generally parallel to the Z direction. Hereinafter, as necessary, the first protruding conductor portion 316D from the −Z side will be referred to as a first protruding conductor portion 316Da, the second protruding conductor portion 316D from the −Z side will be referred to as a second protruding conductor portion 316Db, and the third protruding conductor portion 316D from the −Z side will be referred to as a third protruding conductor portion 316Dc.

The first protruding conductor portion 316Da protrudes from the −Z side edge of the first conductor portion 312D toward the +X side. The second protruding conductor portion 316Db protrudes from the substantially central portion of the first conductor portion 312D in the Z direction toward the +X side. The second protruding conductor portion 316Db is bent at substantially 90°with respect to the first conductor portion 312D by a cutting and bending process. An opening 313D remains in a portion of the first conductor portion 312D where the second protruding conductor portion 316Db is cut out. The third protruding conductor portion 316Dc protrudes from the +Z side edge of the first conductor portion 312D toward the +Z side. In the example shown in FIG. 13, positions of the first protruding conductor portion 316Da, the third protruding conductor portion 316Dc, and the second protruding conductor portion 316Db in the Y direction are substantially aligned in the Y direction.

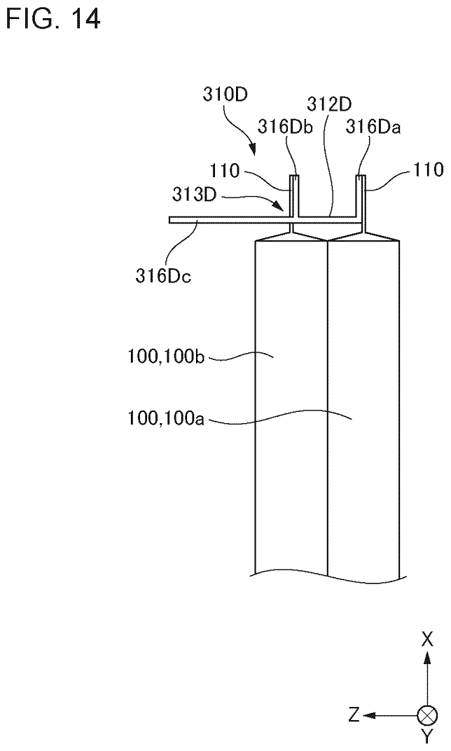

Next, as shown in FIG. 14, the plurality of positive electrode current collectors 110 of the first battery element 100a are disposed on the −Z side with respect to the first protruding conductor portion 316Da. The plurality of positive electrode current collectors 110 of the first battery element 100a are joined to each other by a joining method such as ultrasonic welding in advance. Next, the plurality of positive electrode current collectors 110 of the first battery element 100a are irradiated with a laser from the −Z side to join the +Z side surface of the plurality of positive electrode current collectors 110 of the first battery element 100a and the −Z side surface of the first protruding conductor portion 316Da to each other.

Next, he plurality of positive electrode current collectors 110 of the second battery element 100b are passed through the opening 313D, and the plurality of positive electrode current collectors 110 of the second battery element 100b are disposed on the +Z side with respect to the second protruding conductor portion 316Db. The plurality of positive electrode current collectors 110 of the second battery element 100b are joined to each other by a joining method such as ultrasonic welding in advance. Next, the plurality of positive electrode current collectors 110 of the second battery element 100b are irradiated with a laser from the +Z side to join the −Z side surface of the plurality of positive electrode current collectors 110 of the second battery element 100b and the +Z side surface of the second protruding conductor portion 316Db to each other.

A method of joining the plurality of positive electrode current collectors 110 of each of the first battery element 100a and the second battery element 100b to the first protruding conductor portion 316Da and the second protruding conductor portion 316Db to each other is not limited to the above-described example. For example, the plurality of positive electrode current collectors 110 of the first battery element 100a may be disposed on the −Z side with respect to the first protruding conductor portion 316Da, and the plurality of positive electrode current collectors 110 of the second battery element 100b may be disposed on the +Z side with respect to the second protruding conductor portion 316Db, and then the plurality of positive electrode current collectors 110 of the first battery element 100a may be irradiated with a laser from the −Z side, and the plurality of positive electrode current collectors 110 of the second battery element 100b may be irradiated with a laser from the +Z side.

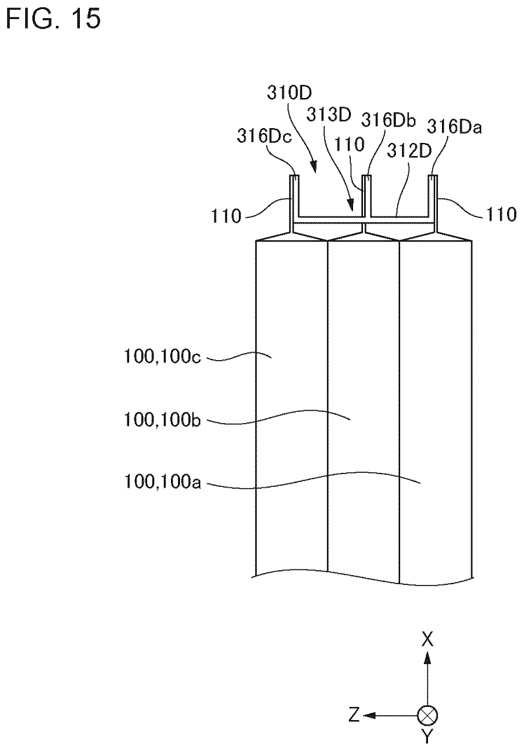

Next, as shown in FIG. 15, the third protruding conductor portion 316Dc is bent at substantially 90° toward the +X side with respect to the first conductor portion 312D. In the example shown in FIGS. 13 to 15, the plurality of positive electrode current collectors 110 of the second battery element 100b and the second protruding conductor portion 316Db are joined to each other, and then the third protruding conductor portion 316Dc is bent at substantially 90° toward the +X side with respect to the first conductor portion 312D. Therefore, the third protruding conductor portion 316Dc can be prevented from interfering with the laser emitted from the +Z side of the plurality of positive electrode current collectors 110 of the second battery element 100b when joining the plurality of positive electrode current collectors 110 of the second battery element 100b to the second protruding conductor portion 316Db to each other.

Next, the plurality of positive electrode current collectors 110 of the third battery element 100c are disposed on the +Z side with respect to the third protruding conductor portion 316Dc. The plurality of positive electrode current collectors 110 of the third battery element 100c are joined to each other by a joining method such as ultrasonic welding in advance. Next, the plurality of positive electrode current collectors 110 of the third battery element 100c are irradiated with a laser from the +Z side to join the −Z side surface of the plurality of positive electrode current collectors 110 of the third battery element 100c and the +Z side surface of the third protruding conductor portion 316Dc to each other.

The third protruding conductor portion 316Dc may be bent in advance toward the −X side with the second protruding conductor portion 316Db bent toward the +X side. Even when the third protruding conductor portion 316Dc is bent toward the −X side, the plurality of positive electrode current collectors 110 of the first battery element 100a and the third protruding conductor portion 316Dc can be joined to each other by laser irradiation. When the third protruding conductor portion 316Dc is bent in advance toward the −X side, the third protruding conductor portion 316Dc can be prevented from interfering with the laser emitted from the +Z side of the plurality of positive electrode current collectors 110 of the second battery element 100b when joining the plurality of positive electrode current collectors 110 of the second battery element 100b to the second protruding conductor portion 316Db to each other. Therefore, the third protruding conductor portion 316Dc can be bent in advance with respect to the first conductor portion 312D before the plurality of positive electrode current collectors 110 of each of the first battery element 100a and the second battery element 100b are joined to the first protruding conductor portion 316Da and the second protruding conductor portion 316Db to each other.

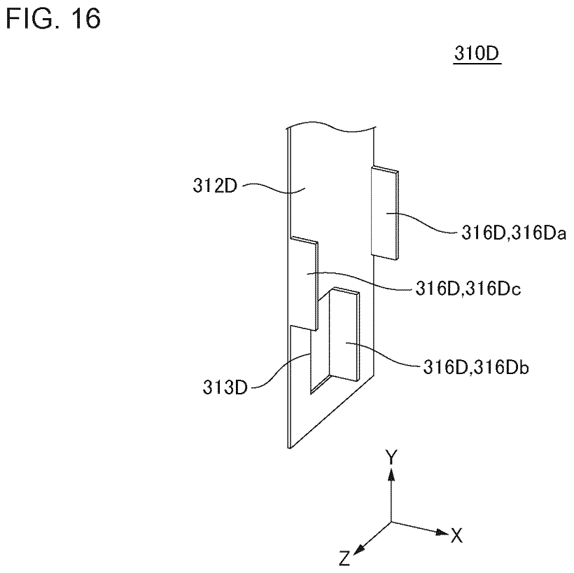

FIG. 16 is a diagram showing a first variant of FIG. 13. The example shown in FIG. 16 is the same as the example shown in FIG. 13, except for the following points.

In the example shown in FIG. 16, the third protruding conductor portion 316Dc is bent at substantially 90° toward the +X side with respect to the first conductor portion 312D in advance. However, in the example shown in FIG. 16, a position of the second protruding conductor portion 316Db in the Y direction is shifted to the −Y side with respect to a position of the third protruding conductor portion 316Dc in the Y direction and a position of the first protruding conductor portion 316Da in the Y direction. Therefore, even when the third protruding conductor portion 316Dc is bent at substantially 90° toward the +X side with respect to the first conductor portion 312D in advance, the third protruding conductor portion 316Dc can be prevented from interfering with the laser emitted from the +Z side of the plurality of positive electrode current collectors 110 of the second battery element 100b when joining the plurality of positive electrode current collectors 110 of the second battery element 100b to the second protruding conductor portion 316Db to each other. Therefore, in the example shown in FIG. 16, the third protruding conductor portion 316Dc can be bent in advance with respect to the first conductor portion 312D before the plurality of positive electrode current collectors 110 of each of the first battery element 100a and the second battery element 100b are joined to the first protruding conductor portion 316Da and the second protruding conductor portion 316Db to each other.

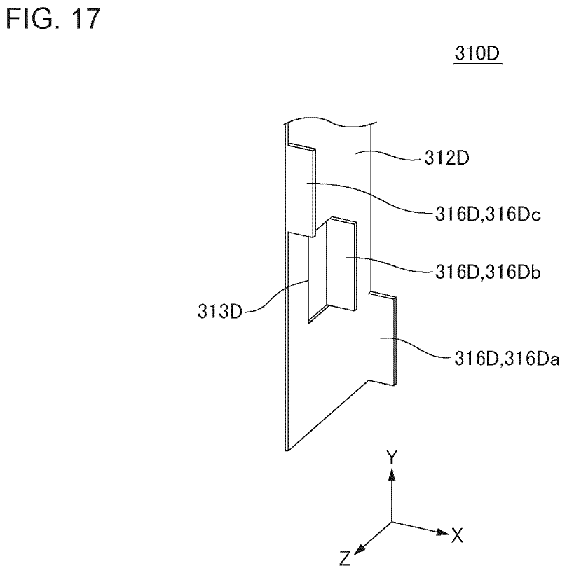

FIG. 17 is a diagram showing a second variant of FIG. 13. The example shown in FIG. 17 is the same as the example shown in FIG. 13, except for the following points.

In the example shown in FIG. 17, a position of the first protruding conductor portion 316Da in the Y direction is shifted to the −Y side with respect to a position of the second protruding conductor portion 316Db in the Y direction. A position of the third protruding conductor portion 316Dc in the Y direction is shifted to the +Y side with respect to a position of the second protruding conductor portion 316Db in the Y direction. Therefore, the third protruding conductor portion 316Dc can be bent in advance with respect to the first conductor portion 312D before the plurality of positive electrode current collectors 110 of each of the first battery element 100a and the second battery element 100b are joined to the first protruding conductor portion 316Da and the second protruding conductor portion 316Db to each other in the same manner as in the example shown in FIG. 16. In addition, in the example shown in FIG. 17, when joining the plurality of positive electrode current collectors 110 of each battery element 100 and each protruding conductor portion 316D to each other by laser irradiation, the laser can be emitted from the same side of the +Z side or the −Z side for all the protruding conductor portions 316D.

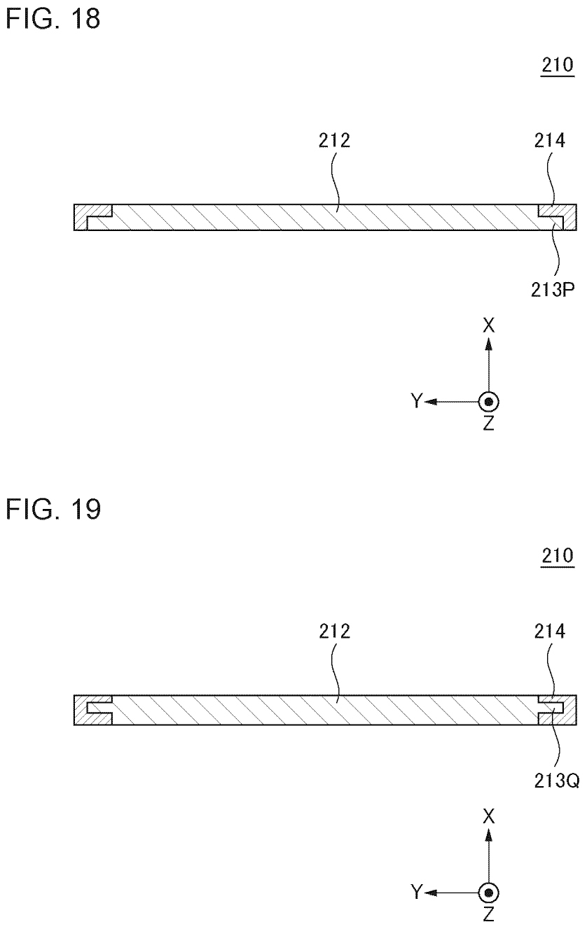

FIG. 18 is a diagram showing a first example of a cross section of the front lid member 210 according to Embodiment 1 or 2. FIG. 18 shows a cross section of the front lid member 210 perpendicular to the Z direction.

In the example shown in FIG. 18, a protrusion 213P is provided on the outer peripheral surface of the front metal portion 212. The protrusion 213P protrudes in a direction generally perpendicular to the X direction. The protrusion 213P is positioned at the rear end part of the front metal portion 212. The protrusion 213P may continuously extend along the entire periphery of the outer peripheral surface of the front metal portion 212 or may be intermittently positioned along the entire periphery of the outer peripheral surface of the front metal portion 212. The protrusion 213P causes the front metal portion 212 to have at least one of a recessed portion and a protruding portion at an interface between the front metal portion 212 and the front resin portion 214. Therefore, the contact area between the front metal portion 212 and the front resin portion 214 can be increased as compared with a case where the outer peripheral surface of the front metal portion 212 is flat at the interface between the front metal portion 212 and the front resin portion 214. Therefore, the front metal portion 212 and the front resin portion 214 can be firmly joined to each other as compared with the above-described case.

FIG. 19 is a diagram showing a second example of the cross section of the front lid member 210 according to Embodiment 1 or 2. The second example shown in FIG. 19 is the same as the first example shown in FIG. 18, except for the following points.

In the example shown in FIG. 19, a protrusion 2130 is provided on the outer peripheral surface of the front metal portion 212. The protrusion 2130 is positioned at the substantially central portion of the front metal portion 212 in the X direction. In the example shown in FIG. 19, the front metal portion 212 also has at least one of a recessed portion and a protruding portion at the interface between the front metal portion 212 and the front resin portion 214. Therefore, the front metal portion 212 and the front resin portion 214 can be firmly joined to each other as compared with a case where the outer peripheral surface of the front metal portion 212 is flat at the interface between the front metal portion 212 and the front resin portion 214.

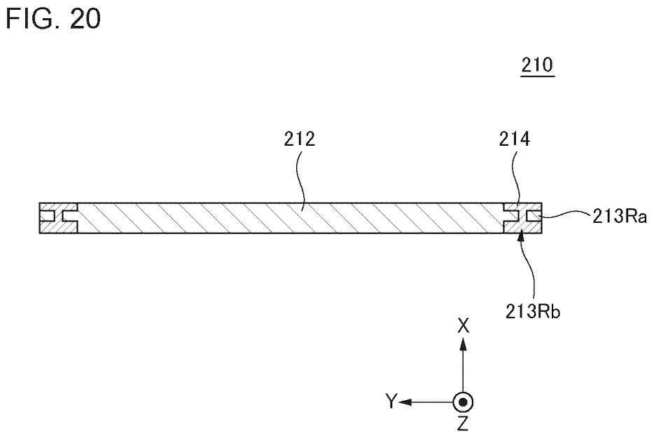

FIG. 20 is a diagram showing a third example of the cross section of the front lid member 210 according to Embodiment 1 or 2. The third example shown in FIG. 20 is the same as the first example shown in FIG. 18, except for the following points.

In the example shown in FIG. 20, a protrusion 213Ra is provided on the outer peripheral surface of the front metal portion 212. The protrusion 213Ra defines a hole 213Rb. The hole 213Rb penetrates the protrusion 213Ra generally parallel to the X direction. Therefore, a part of the front resin portion 214 can enter the hole 213Rb. In the example shown in FIG. 20, the front metal portion 212 also has at least one of a recessed portion and a protruding portion at the interface between the front metal portion 212 and the front resin portion 214. Therefore, the front metal portion 212 and the front resin portion 214 can be firmly joined to each other as compared with a case where the outer peripheral surface of the front metal portion 212 is flat at the interface between the front metal portion 212 and the front resin portion 214.

Although the embodiments and variants of the present invention have been described above with reference to the accompanying drawings, these are merely examples of the present invention, and various other configurations may be employed.

For example, in each embodiment, the positive electrode terminal and the negative electrode terminal are disposed on opposite sides of the battery element 100 in the X direction. However, both the positive electrode terminal and the negative electrode terminal may be disposed only on one of the front side or the rear side of the battery element 100 in the X direction. In this case, the front end part and the rear end part of the battery element 100 are covered with, for example, two lid members. Alternatively, only the side from which the positive electrode terminal and the negative electrode terminal of the battery element 100 are drawn out may be covered with the lid member. In this example, on a side of the battery element 100 opposite to the lid member, the exterior film 400 may be sealed and folded along the battery element 100.

This application claims priority based on Japanese Patent Application No. 2023-070016 filed on Apr. 21, 2023, the entire disclosure of which is incorporated herein by reference.

### REFERENCE SIGNS LIST

10A, 10B, 10C battery cell, 100 battery element, 100a first battery element, 100b second battery element, 100c third battery element, 110 positive electrode current collector, 112 distal end part, 210 front lid member, 212 front metal portion, 213P, 2130, 213Ra protrusion, 213Rb hole, 214 front resin portion, 216 positive electrode terminal, 220 rear lid member, 222 rear metal portion, 224 rear resin portion, 310A, 310B, 310C, 310D connecting conductor, 312A, 312B, 312C, 312D first conductor portion, 313D opening, 314A, 314B, 314C second conductor portion, 316A, 316C, 316D protruding conductor portion, 316Da first protruding conductor portion, 316Db second protruding conductor portion, 316Dc third protruding conductor portion, 350B thermally insulating material, 400 exterior film

1. A battery cell comprising:
a battery element having a predetermined end surface from which a current collector is drawn out;
a lid member that covers the predetermined end surface of the battery element; and
a connecting conductor that has a first conductor portion electrically connected to the current collector and a second conductor portion electrically connected to the lid member,
wherein the connecting conductor is bent between the first conductor portion and the second conductor portion.

2. The battery cell according to claim 1,
wherein at least a part of the current collector is bent non-perpendicularly with respect to the predetermined end surface of the battery element.

3. The battery cell according to claim 2,
wherein the connecting conductor further has a protruding conductor portion that protrudes from the first conductor portion and is joined to the current collector.

4. The battery cell according to claim 2,
wherein the first conductor portion and the current collector are joined to each other at a position overlapping the predetermined end surface of the battery element.

5. The battery cell according to claim 4, further comprising:
a thermally insulating material that is positioned between the position at which the first conductor portion and the current collector are joined to each other and the predetermined end surface of the battery element.

6. The battery cell according to claim 1, wherein a rigidity of a bent portion of the connecting conductor between the first conductor portion and the second conductor portion is lower than at least one of a rigidity of the first conductor portion and a rigidity of the second conductor portion.

7. The battery cell according to claim 1, wherein the lid member has a metal portion that is electrically connected to the second conductor portion and a resin portion that surrounds the metal portion.

8. The battery cell according to claim 7, wherein the metal portion has at least one of a recessed portion and a protruding portion at an interface between the metal portion and the resin portion.

9. A method of manufacturing a battery cell, the method comprising:
a step of electrically connecting a current collector drawn out from a predetermined end surface of a battery element and a first conductor portion of a connecting conductor to each other;
a step of electrically connecting a lid member and a second conductor portion of the connecting conductor to each other; and
a step of bending the connecting conductor between the first conductor portion and the second conductor portion to cover the predetermined end surface of the battery element with the lid member.

10. The method of manufacturing a battery cell according to claim 9,
wherein the step of electrically connecting the lid member and the second conductor portion to each other includes a step of joining the lid member and the second conductor portion to each other when the second conductor portion is non-parallel to the predetermined end surface of the battery element.

11. The method of manufacturing a battery cell according to claim 9,
wherein the step of electrically connecting the current collector and the first conductor portion to each other includes a step of bending at least a part of the current collector non-perpendicularly with respect to the predetermined end surface of the battery element.

12. The method of manufacturing a battery cell according to claim 11,
wherein the step of electrically connecting the current collector and the first conductor portion to each other includes a step of joining the current collector and a protruding conductor portion that protrudes from the first conductor portion of the connecting conductor to each other.

13. The method of manufacturing a battery cell according to claim 11,
wherein the step of electrically connecting the current collector and the first conductor portion to each other includes a step of joining the current collector and the first conductor portion to each other at a position overlapping the predetermined end surface of the battery element.

14. The method of manufacturing a battery cell according to claim 13,
wherein in the step of joining the current collector and the first conductor portion to each other, a thermally insulating material is positioned between the position at which the first conductor portion and the current collector are joined to each other and the predetermined end surface of the battery element.
